(19) United States
(12) Patent Application Publication
(10) Pub. No.: US 2002/0030895 A1
(43) Pub. Date: Mar. 14, 2002

(54) Zoom viewfinder

(75) Inventor: Tetsuro Tani, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/880,966

(22) Filed: Jun. 15, 2001

(30) Foreign Application Priority Data
Jun. 16, 2000 (JP) 2000-181384(P)

(51) Int. Cl. G02B 15/14; G02B 15/22

(52) U.S. Cl. 359/699; 359/700; 359/701; 359/703; 359/704; 359/705

(57) ABSTRACT

A zoom viewfinder includes an objective optical system having a frontmost lens group and a movable lens group positioned behind the frontmost lens group, and a guide shaft which extends parallel to an optical axis of the objective optical system to guide the movable lens group in the optical axis direction. The frontmost end of the guide shaft is positioned behind the frontmost lens group of the objective optical system.

### BACKGROUND OF THE INVENTION

1. Field of the Invention

The present invention relates to a zoom viewfinder which can be incorporated in a zoom compact camera.

2. Description of the Related Art

In a typical real-image type zoom viewfinder, an objective optical system is provided therein with a plurality of movable lens groups (zoom lens groups), and a real image formed via the objective optical system is viewed through an eyepiece optical system. As a guide mechanism for guiding the movable lens groups in a direction of the optical axis thereof, a guide mechanism having one or more guide shafts which extend parallel to the optical axis so that the movable lens groups are supported and guided by the guide shaft to be slidable thereon is known in the art. However, such a conventional guide mechanism is designed with little regard for the positional relationship between the guide shaft and the lens groups of the zoom viewfinder. This is a leading cause of an increased size of the zoom viewfinder.

### SUMMARY OF THE INVENTION

An object of the present invention is to provide a compact zoom viewfinder in which an improvement in the positional relationship between the guide shaft and the lens groups of the zoom viewfinder is achieved.

To achieve the objects mentioned above, according to an aspect of the present invention, a zoom viewfinder is provided, including an objective optical system having a frontmost lens group and a movable lens group positioned behind the frontmost lens group; and a guide shaft which extends parallel to an optical axis of the objective optical system to guide the movable lens group in the optical axis direction. The frontmost end of the guide shaft is positioned behind the frontmost lens group of the objective optical system.

Preferably, the guide shaft is positioned within an outer contour of the frontmost lens group, as viewed from the optical axis direction.

Preferably, the frontmost lens group has a positive power, and the guide shaft is disposed in a space behind the frontmost lens group, the space not interfering with light rays of an object image which are passed through the frontmost lens group.

According to another aspect of the present invention, a real-image type zoom viewfinder is provided, including an objective optical system having a first lens group, a second lens group and a third lens group, in that order from an object side, each of the second and third lens groups being guided in an optical axis direction of the objective optical system; and a guide shaft which extends parallel to the optical axis to guide the third lens group in the optical axis direction. The frontmost end of the guide shaft is positioned behind the first lens group.

In an embodiment, the real-image type zoom viewfinder further includes another guide shaft which extends parallel to the optical axis to guide the first lens group and the second lens group in the optical axis direction, wherein a distance from the optical axis to the guide shaft is shorter than a distance from the optical axis to the another guide shaft.

Preferably, the real-image type zoom viewfinder further includes a spring which biases the first lens group toward the front of the objective optical system, and an adjustment screw with which an axial position of the first lens group can be adjusted.

According to another aspect of the present invention, a real-image type zoom viewfinder is provided, including an objective optical system including a frontmost lens group having a positive power; a front movable lens group and a rear movable lens group which are positioned behind the frontmost lens group; a first guide shaft which extends parallel to the optical axis to guide the frontmost lens group and the front movable lens group in the optical axis direction; and a second guide shaft which extends parallel to the first guide shaft to guide the rear movable lens group in the optical axis direction. A distance from the optical axis to the second guide shaft is shorter than a distance from the optical axis to the first guide shaft.

Preferably, the real-image type zoom viewfinder further includes a spring which biases the frontmost lens group toward the front of the objective optical system; and an adjustment screw with which an axial position of the frontmost lens group can be adjusted.

According to another aspect of the present invention, a zoom viewfinder is provided, including an objective optical system having a frontmost lens group and at least one movable lens group positioned behind the frontmost lens group; and a guide shaft which extends parallel to an optical axis of the objective optical system to guide the at least one movable lens group along the optical axis; wherein one end of the guide shaft is positioned behind the frontmost lens group.

Preferably, the frontmost lens group has a positive power.

The present disclosure relates to subject matter contained in Japanese Patent Application No.2000-181384 (filed on Jun. 16, 2000) is expressly incorporated herein by reference in its entirety.

### BRIEF DESCRIPTION OF THE DRAWINGS

The present invention will be described below in detail with reference to the accompanying drawings in which:

FIG. 1 is a perspective view of an embodiment of a zoom viewfinder system, viewed from the objective optical system side thereof;

FIG. 2 is a perspective view of the zoom viewfinder system shown in FIG. 1, viewed from the eyepiece optical system side thereof;

FIG. 3 is a perspective view of the zoom viewfinder system shown in FIG. 1 in a state where a cam plate is removed, viewed from the objective optical system side of the zoom viewfinder system;

FIG. 4 is a front elevational view of the zoom viewfinder system shown in FIG. 1;

FIG. 5 is a cross sectional view of the zoom viewfinder system shown in FIG. 1, taken along a V-V line in FIG. 4, viewed in the direction of the appended arrows; and

FIG. 6 is a cross sectional view of the zoom viewfinder system shown in FIG. 1, taken along VI-VI line in FIG. 4, viewed in the direction of the appended arrows.

### DESCRIPTION OF THE PREFERRED EMBODIMENT

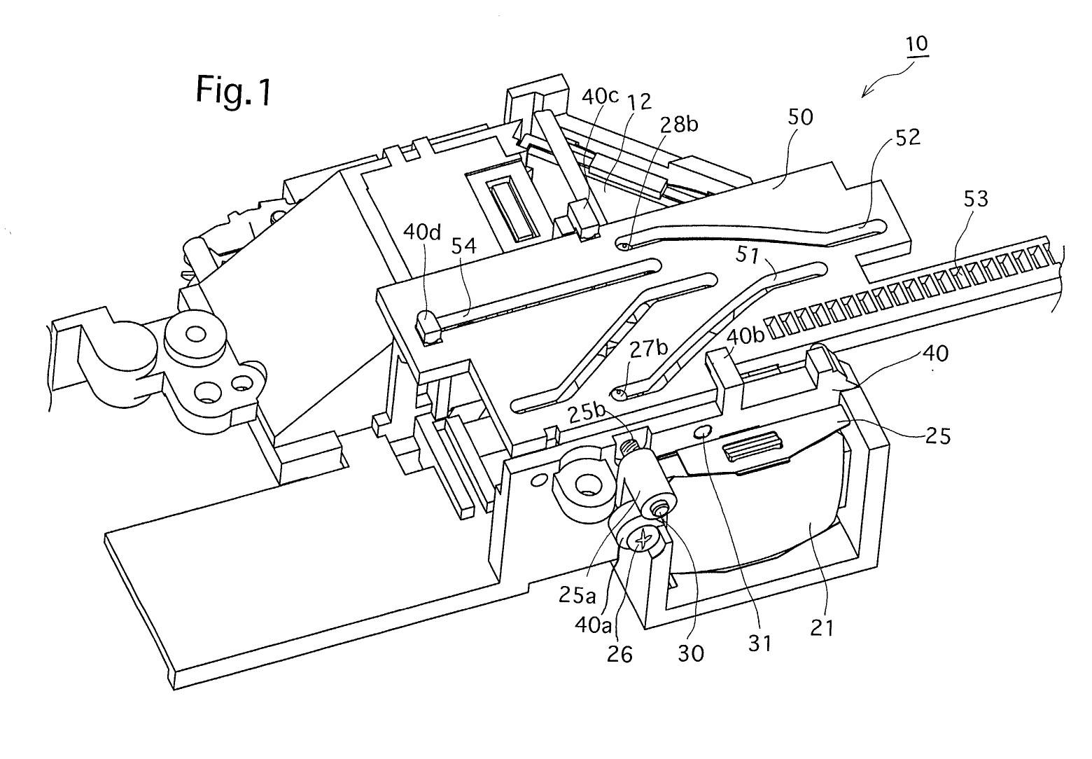

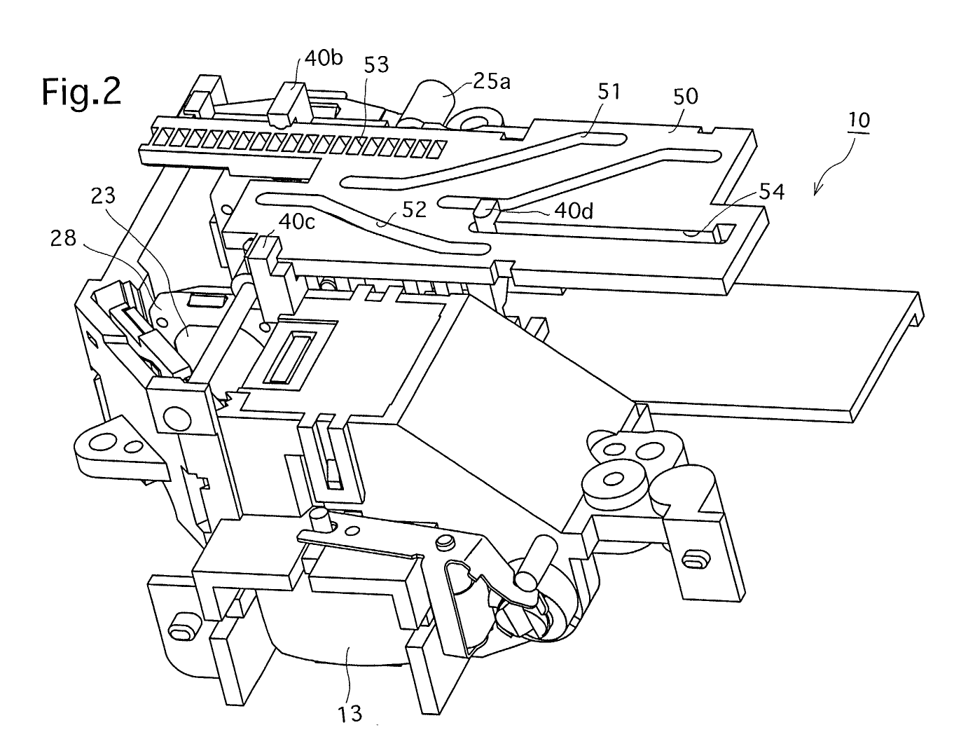

FIGS. 1 through 6 show an embodiment of a zoom viewfinder system (real-image type zoom viewfinder) 10, according to the present invention, which can be incorporated in a zoom compact camera, e.g., a conventional camera using sensitive film or a digital camera.

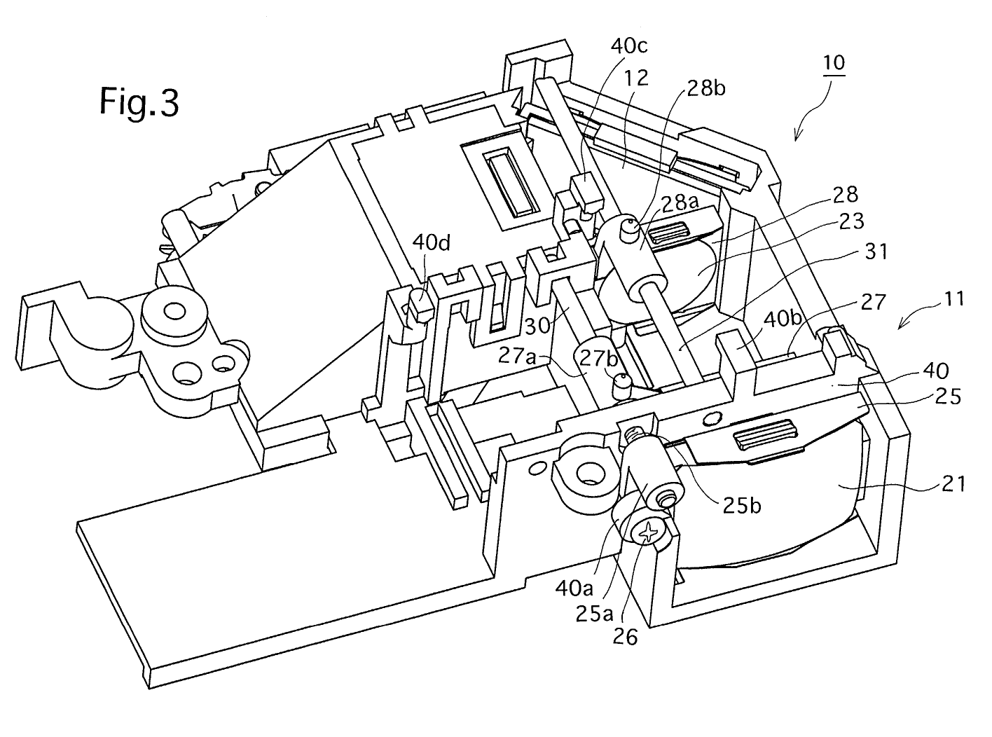

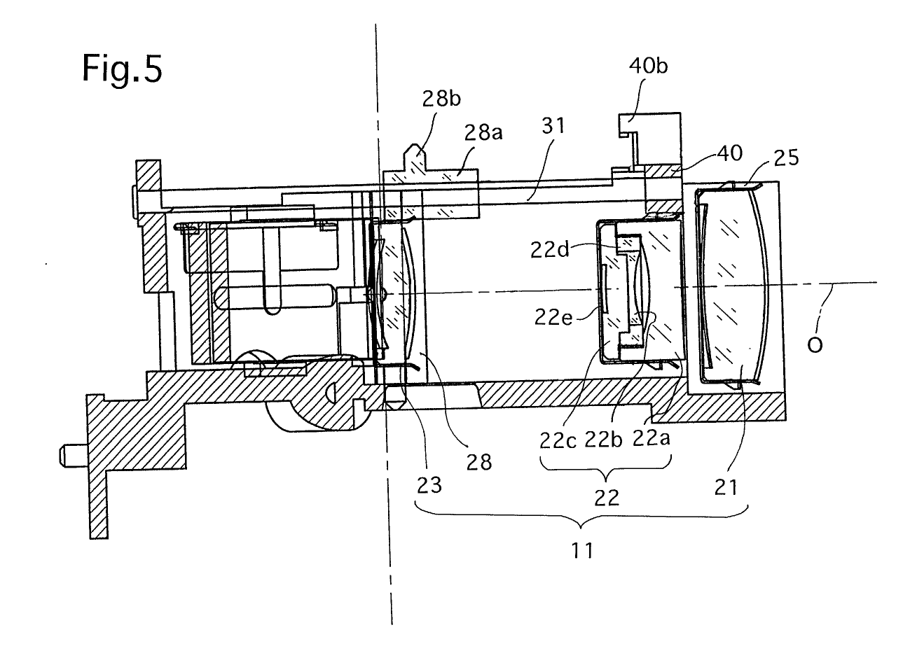

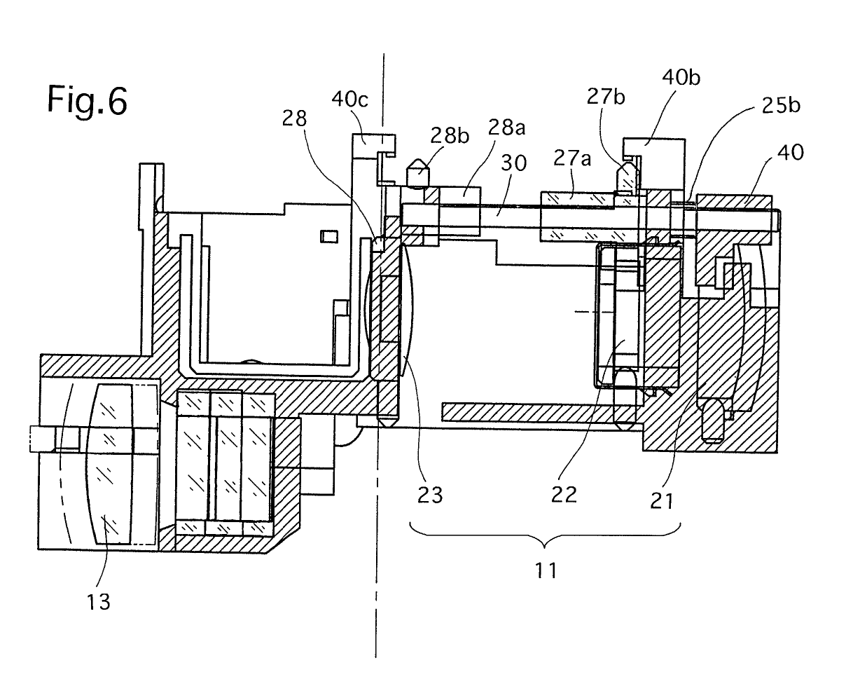

The zoom viewfinder system 10 is provided with a viewfinder optical system consisting of an objective optical system 11, an erecting system (not shown) and an eyepiece optical system 13, in that order from the object side (i.e., right to left as shown in FIG. 5 or 6). An inverted image (real image) is converted into an erect image via the erecting system to be viewed through the eyepiece optical system 13. The erecting system is provided with four reflection surfaces. A mirror 12 shown in FIGS. 1 and 3 that is provided as an element of the zoom viewfinder system 10 serves as one of the four reflection surfaces of the erecting system.

The objective optical system 11 includes a first lens group (frontmost lens group) 21, a second lens group (front movable lens group) 22 and a third lens group (rear movable lens group) 23, in that order from the object side. The first lens group 21 has a positive power. The second lens group 22 and the third lens group 23 are movable lens groups which are driven in an optical axis direction of the objective optical system 11 (i.e., the optical axis direction of the objective optical system 11) to perform a zooming operation, i.e., to continuously vary the focal length of the viewfinder optical system without disturbing focus. The first lens group 21 is stationary during a zooming operation. The above-described structure of the zoom viewfinder system 10 is known in the art.

The first lens group 21 is supported by a first support frame 25 with which a first guide cylinder 25a is formed integral. The second lens group 22 is supported by a second support frame 27 (see FIG. 3) which has a second guide cylinder 27a formed integral therewith. As shown in FIG. 5, the second lens group 22 is constructed from three lens elements, wherein a first lens element 22a which is provided on the first lens group 21 side of the second lens group 22 is formed integral with the second support frame 27 (see FIG. 6). The remaining second and third lens elements 22b and 22c are attached to the first lens element 22a by a leaf spring 22e via a spacer 22d.

Each of the first and second guide cylinders 25a and 27a is slidably fitted on a first guide shaft 30 which extends parallel to the optical axis O of the objective optical system 11, and is accordingly guided in the optical axis direction of the objective optical system 11 by the first guide shaft 30. The first support frame 25 is constantly biased toward the front of the objective optical system 11 in the optical axis direction (i.e., to the right as shown in FIG. 5) by a compression coil spring 25b (see FIGS. 1 and 3). The compression coil spring 25b is fitted on the first guide shaft 30 and held between the rear end of the second guide cylinder 25a and a front surface of an outer frame member 40 of the zoom viewfinder system 10. The first support frame 25 is prevented from moving forward beyond a predetermined point by an adjustment screw 26 which is screwed into a portion of the outer frame member 40. The axial position of the first lens group 21 can be adjusted by rotating the adjusting screw 26 forward or reverse during assembly. The outer frame member 40 is formed integral with the first lens group 21.

The third lens group 23 is supported by a third support frame 28 which has a third guide cylinder 28a formed integral therewith. The third guide cylinder 28a is slidably fitted on a second guide shaft 31 which extends parallel to the optical axis O of the objective optical system 11, and is accordingly guided in the optical axis direction of the objective optical system 11 by the second guide shaft 31. The third support frame 28 is formed integral with the third lens group 23.

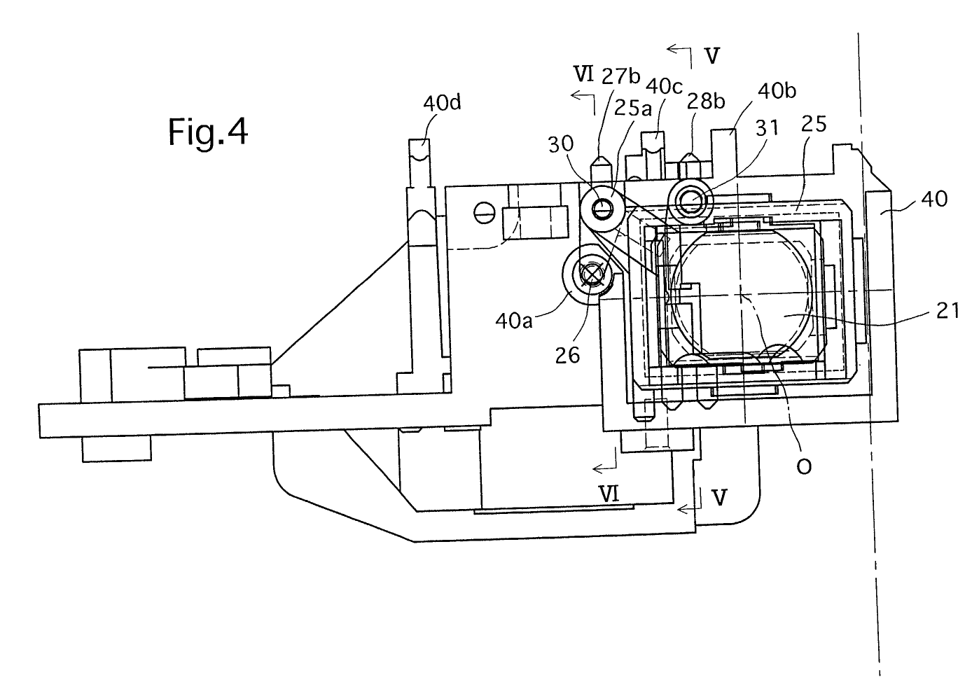

As shown in FIGS. 3 and 5, the opposite ends of the second guide shaft 31 are respectively supported by corresponding portions of the outer frame member 40. The front end (right end as shown in FIG. 5) of the second guide shaft 31 is positioned behind the first lens group 21 (the first support frame 25). Moreover, as shown in FIG. 4, at least part of the second guide shaft 31 is positioned within the outer contour of the first lens group 21 as viewed from the front or rear of the optical axis direction of the objective optical system 11. In other words, the distance from the optical axis O of the objective optical system 11 to the second guide shaft 31 is shorter than the distance from the optical axis O of the objective optical system 11 to the first guide shaft 30.

Such an arrangement wherein at least part of the second guide shaft 31 is positioned within the outer contour of the first lens group 21, as viewed from the optical axis direction of the objective optical system 11, is effective for reducing the size of the zoom viewfinder system 10. This arrangement can be easily achieved with the objective optical system 11 since the first lens group 21 has a positive power and therefore light rays which pass through the first lens group 21 are bent toward the optical axis O via the first lens group 21. Accordingly, the outer contour of each of the second lens group 22 and the third lens group 23 can be made smaller than the outer contour of the first lens group 21 to form a space behind the first lens group 21 which does not interfere with light rays of the object image which are passed through the first lens group 21. Accordingly, the second guide shaft 31 can be disposed in the space behind the first lens group 21.

With the above described structure, the outer contour of the first lens group 21 imposes little restriction on the positioning of the second guide shaft 31, and accordingly, the reducing in size of the zoom viewfinder system 10 is achieved by positioning the second guide shaft 31 in the vicinity of the optical axis O of the objective optical system 11.

First and second cam followers 27b and 28b project upwards from the second and third guide cylinders 27a and 28a to be engaged in first and second cam slots (through slots) 51 and 52 formed on a cam plate 50 (see FIG. 1), respectively. The cam plate 50 is guided linearly (in the horizontal direction as shown in FIG. 4) via a front support projection 40b, a rear support projection 40c and a middle support projection 40d. The middle projection 40d is slidably engaged in a linear guide groove 54 formed on the cam plate 50, while the front and rear support projections 40b and 40c hold the guide plate 50 from opposite sides thereof so that the front and rear edges of the guide plate 50 can slide along the front and rear support projections 40b and 40c, respectively. The cam plate 50 is provided thereon with a rack portion 53 which is engaged with a pinion gear (not shown). Forward and reverse rotation of the pinion gear causes the cam plate 50 to move right and left linearly. The contour of the first cam slot 51 is determined to correspond to a predetermined zoom path of the second lens group 22. Similarly, the contour of the second cam slot 52 is determined to correspond to a predetermined zoom path of the third lens group 23. Accordingly, driving the cam plate 50 causes each of the second and third lens groups 22 and 23 to move in the direction of the optical axis O along each corresponding zoom path in order to perform zooming.

In the above described embodiment of the zoom viewfinder system 10, although only the third lens group 23 among all the movable lens groups is guided in the direction of the optical axis O by the second guide shaft 31, both the second and third lens groups 22 and 23 can be guided in the same direction by the second guide shaft 31.

Although the above described embodiment of the zoom viewfinder system 10 is provided with the objective optical system 11 consisting of three lens groups (21, 22 and 23), the present invention is not limited solely to the particular number of the lens groups of the objective optical system 11.

Although the above described zoom viewfinder system 10 is a real-image type zoom viewfinder system, the present invention can also be applied to a virtual-image type zoom viewfinder system, e.g., a Galilean zoom viewfinder system.

As can be understood from the foregoing, according to the present invention, a compact zoom viewfinder is provided in which an improvement in the positional relationship between the guide shaft and the lens groups of the zoom viewfinder can be achieved.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A zoom viewfinder comprising:
an objective optical system having a frontmost lens group and a movable lens group positioned behind said frontmost lens group; and
a guide shaft which extends parallel to an optical axis of said objective optical system to guide said movable lens group in said optical axis direction,
wherein the frontmost end of said guide shaft is positioned behind said frontmost lens group of said objective optical system.

2. The zoom viewfinder according to claim 1, wherein said guide shaft is positioned within an outer contour of said frontmost lens group, as viewed from said optical axis direction.

3. The zoom viewfinder according to claim 2, wherein said frontmost lens group has a positive power; and
wherein said guide shaft is disposed in a space behind said frontmost lens group, said space not interfering with light rays of an object image which are passed through said frontmost lens group.

4. A real-image type zoom viewfinder comprising:
an objective optical system having a first lens group, a second lens group and a third lens group, in that order from an object side, each of said second and third lens groups being guided in an optical axis direction of said objective optical system; and
a guide shaft which extends parallel to said optical axis to guide said third lens group in said optical axis direction;
wherein the frontmost end of said guide shaft is positioned behind said first lens group.

5. The real-image type zoom viewfinder according to claim 4, further comprising another guide shaft which extends parallel to said optical axis to guide said first lens group and said second lens group in said optical axis direction;
wherein a distance from said optical axis to said guide shaft is shorter than a distance from said optical axis to said another guide shaft.

6. The real-image type zoom viewfinder according to claim 5, further comprising:
a spring which biases said first lens group toward the front of said objective optical system; and
an adjustment screw with which an axial position of said first lens group can be adjusted.

7. A real-image type zoom viewfinder comprising:
an objective optical system including a frontmost lens group having a positive power;
a front movable lens group and a rear movable lens group which are positioned behind said frontmost lens group;
a first guide shaft which extends parallel to said optical axis to guide said frontmost lens group and said front movable lens group in said optical axis direction; and
a second guide shaft which extends parallel to said first guide shaft to guide said rear movable lens group in said optical axis direction;
wherein a distance from said optical axis to said second guide shaft is shorter than a distance from said optical axis to said first guide shaft.

8. The real-image type zoom viewfinder according to claim 7, further comprising:
a spring which biases said frontmost lens group toward the front of said objective optical system; and
an adjustment screw with which an axial position of said frontmost lens group can be adjusted.

9. A zoom viewfinder comprising:
an objective optical system having a frontmost lens group and at least one movable lens group positioned behind said frontmost lens group; and
a guide shaft which extends parallel to an optical axis of said objective optical system to guide said at least one movable lens group along said optical axis;
wherein one end of said guide shaft is positioned behind said frontmost lens group.

10. The zoom viewfinder according to claim 9, wherein said frontmost lens group has a positive power.
